(19) United States
(12) Patent Application Publication
(10) Pub. No.: US 2025/0112395 A1
(43) Pub. Date: Apr. 3, 2025

(54) CONNECTOR

(71) Applicant: SUMITOMO WIRING SYSTEMS, LTD., Mie (JP)

(72) Inventor: Akihisa OGAWA, Mie (JP)

(21) Appl. No.: 18/893,444

(22) Filed: Sep. 23, 2024

(30) Foreign Application Priority Data
Sep. 29, 2023 (JP) 2023-169505

(51) Int. Cl. H01R 13/436

(52) U.S. Cl. CPC H01R 13/4362

(57) ABSTRACT

A housing includes one surface, a side surface intersecting the one surface, a retainer attachment hole that is open in the one surface and the side surface, and locking portions and protruding from the side surface. A retainer includes a body portion disposed inside the retainer attachment hole and capable of locking the terminal fitting, and a side plate portion that protrudes from the body portion in a direction intersecting the direction of movement of the retainer and covers the side surface from outside. The side plate portion includes a locked portion protruding from an inner surface and configured to be locked to the locking portions and. The locking portions and each include, on an end face thereof facing toward an opening of the retainer attachment hole, an inclined surface portion that is inclined in a direction away from the opening of the retainer attachment hole.

### CROSS-REFERENCE TO RELATED APPLICATIONS

This application is based on and claims priority from Japanese Patent Application No. 2023-169505, filed on Sep. 29, 2023, with the Japan Patent Office, the disclosure of which is incorporated herein in its entirety by reference.

### TECHNICAL FIELD

The present disclosure relates to a connector.

### BACKGROUND

The connector disclosed in JP 2005-222758 A includes a terminal fitting, and a connector housing that accommodates the terminal fitting, and a retainer disposed so as to be movable between a partial locking state and a full locking state relative to the connector housing. The connector housing is provided with a retainer attachment hole that is open in a bottom surface and both side surfaces thereof. A full locking portion and a partial locking portion (hereinafter simply referred to as “locking portions”) protrude from each of the side surfaces at locations forward of the retainer attachment hole. The retainer includes a substrate disposed in the retainer attachment hole and capable of locking the terminal fitting, and side wall portions that protrude from the substrate and cover the side surfaces. The inner surfaces of the side wall portions are each provided with a lock receiving portion capable of locking to the locking portions. The retainer is inserted into the retainer attachment hole through the opening of the bottom surface, and is moved upward from the partial locking state to the full locking state. At the time of mounting the retainer into the partial locking state (at the time of inserting the retainer into the retainer insertion hole) and moving the retainer from the partial locking state into the full locking state, the lock receiving portion is caused to ride on the locking portions, whereby the side wall portion is elastically deformed outward, using a coupling portion to the substrate as a supporting point. A connector including a retainer is also disclosed in JP 2005-302350 A and JP 2017-027678 A.

### SUMMARY

In the case of JP 2005-222758 A, the locking portions are disposed close to the retainer attachment hole. The supporting points of the deflection movement of the side wall portions are also close to the retainer attachment hole. If the lock receiving portions strongly interfere with and ride on rear end portions (end portions facing toward the opening of the retainer attachment hole) of the locking portions in the process of moving the retainer, a large stress acts on rear end portions of the locking portions. In contrast, when the locking portions are disposed away from the retainer attachment hole, it is possible to prevent the lock receiving portions from strongly interfering with the rear end portions of the locking portions. However, when the locking positions between the lock receiving portions and the corresponding locking portions are located away from the supporting points of the deflection movement of the side wall portions, it may not be possible to secure a sufficient locking force between the lock receiving portions and the corresponding locking portions. This results in the problem that the retaining force of the retainer for the connector housing is reduced.

Therefore, an object of the present disclosure is to provide a connector that can balance the operability and the retaining force of a retainer.

A connector according to the present disclosure includes: a terminal fitting; a housing configured to accommodate the terminal fitting; and a retainer disposed so as to be movable between a partial locking position and a full locking position relative to the housing, wherein the housing includes one surface, a side surface intersecting the one surface, a retainer attachment hole that is open in the one surface and the side surface, and a locking portion protruding from the side surface, the retainer includes a body portion disposed inside the retainer attachment hole and capable of locking the terminal fitting, and a side plate portion that protrudes from the body portion in a direction intersecting a direction of movement of the retainer and covers the side surface from outside, the side plate portion includes a locked portion protruding from an inner surface opposing the side surface and configured to be locked to the locking portion at at least one of the partial locking position and the full locking position, and the locking portion includes, on an end face thereof facing toward an opening of the retainer attachment hole, an inclined surface portion that is inclined in a direction away from the opening of the retainer attachment hole.

According to the present disclosure, it is possible to provide a connector that can balance the operability and the retaining force of a retainer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view showing a state in which a retainer is held in a partial locking position relative to a housing in a connector according to Embodiment 1.

FIG. 2 is a side view showing a state in which the retainer is held in a full locking position relative to the housing.

FIG. 3 is a cross-sectional side view showing a state in which the retainer is held in the full locking position relative to the housing.

FIG. 4 is an enlarged side view showing a portion of the housing that includes a retainer attachment hole and locking portions.

FIG. 5 is an enlarged front view of a side plate portion at an end portion of the retainer.

FIG. 6 is a cross-sectional side view showing an inner surface shape of the side plate portion at an end portion of the retainer.

FIG. 7 is an enlarged cross-sectional plan view showing a state in which a locked portion of the retainer is caused to ride on the locking portions of the housing.

FIG. 8 is an enlarged cross-sectional plan view showing a state in which the locked portions of the retainer are locked to the locking portions of the housing.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A connector according to the present disclosure includes: a terminal fitting; a housing configured to accommodate the terminal fitting; and a retainer disposed so as to be movable between a partial locking position and a full locking position relative to the housing, wherein the housing includes one surface, a side surface intersecting the one surface, a retainer attachment hole that is open in the one surface and the side surface, and a locking portion protruding from the side surface, the retainer includes a body portion disposed inside the retainer attachment hole and capable of locking the terminal fitting, and a side plate portion that protrudes from the body portion in a direction intersecting a direction of movement of the retainer and covers the side surface from outside, the side plate portion includes a locked portion protruding from an inner surface opposing the side surface and configured to be locked to the locking portion at at least one of the partial locking position and the full locking position, and the locking portion includes, on an end face thereof facing toward an opening of the retainer attachment hole, an inclined surface portion that is inclined in a direction away from the opening of the retainer attachment hole.

At the time of mounting the retainer to the partial locking position or moving the retainer from the partial locking position to the full locking position, the locked portion is caused to ride on the locking portion while the side plate portion is elastically deformed. Upon the locked portion coming into contact with the inclined surface portion, the stress acting on the locking portion is dispersed in the length direction of the inclined surface portion (a direction away from the opening of the retainer attachment hole). Accordingly, stress will not be focused on a corner portion or the like of the side plate portion, and therefore the side plate portion can be elastically deformed smoothly, thus making it possible to enhance the operability of the retainer. In addition, the locking portion can be extended toward the opening of the retainer attachment hole by the length of the inclined surface portion, and it is therefore possible to secure the necessary locking force between the locking portion and the locked portion, thus increasing the retaining force of the retainer.

(2) In the connector according to (1) above, it is preferable that the inclined surface portion is inclined at an inclination angle of 45 degrees or less relative to a planar direction of the side surface.

When the inclination angle of the inclined surface portion is 45 degrees or less, it is possible to increase the length of the inclined surface portion, thus enhancing the effect of dispersing the stress acting on the locking portion. In addition, the length of the locking portion including the inclined surface portion can also be increased, and it is therefore possible to secure a sufficient locking force between the locking portion and the locked portion.

(3) In the connector according to (1) or (2) above, it is preferable that the side surface includes, at a position opposite to the opening side of the retainer attachment hole with the locking portion interposed therebetween, a pressing portion that opposes a distal end portion, in a protruding direction, of the side plate portion from outside, and the side plate portion is configured to be displaceable between a cantilevered state in which the side plate portion is disposed away from the pressing portion, and a double-supported state in which the side plate portion is disposed in contact with the pressing portion by the locked portion riding on the locking portion.

As a result of the distal end portion, in the protruding direction, of the side plate portion coming into contact with the pressing portion, the side plate portion is inhibited from being lifted from the side surface. When the locked portion is caused to ride on the locking portion at the time of mounting the retainer to the partial locking position or moving the retainer from the partial locking position to the full locking position, the side plate portion can be elastically deformed into a double-supported state, using the coupling portion to the body portion and the contact portion with the pressing portion as supporting points. As the locked portion clears the locking portion, the side plate portion is elastically returned promptly, thus making it possible to realize a locked state between the locked portion and the locking portion with a good tactile feel. At the time of mounting the retainer to the partial locking position or at the beginning of moving the retainer from the partial locking position to the full locking position, the side plate portion is maintained in a cantilevered state, and it is therefore possible to reduce the mounting resistance or the movement resistance as compared with the case of a double-supported state.

(4) In the connector according to any one of (1) to (3) above, it is preferable that the locking portion includes a partial locking portion configured to lock the locked portion at the partial locking position, and a full locking portion configured to lock the locked portion at the full locking position, and the inclined surface portion is provided on both the full locking portion and the partial locking portion.

The locked portion is caused to ride on the partial locking portion at the time of mounting the retainer to the partial locking position, and the locked portion is caused to ride on the full locking portion at the time of moving the retainer to the full locking position. In both the state of mounting the retainer and the state of moving the retainer, the operability and the retaining force of the retainer can be enhanced by the inclined surface portions, as described in (1) above.

(5) In the connector according to (4) above, it is preferable that the respective inclined surface portions of the full locking portion and the partial locking portion have the same inclination angle relative to the planar direction of the side surface.

The side plate portion can be elastically deformed in the same manner when the locked portion is caused to ride on each of the partial locking portion and the full locking portion, and it is therefore possible to ensure smooth deflection movement of the side plate portion. Moreover, the structure of a mold for molding the inclined surface portion will not become complicated.

### Details of Embodiments of the Present Disclosure

Specific examples of the present disclosure will be described below with reference to the drawings. It should be note that the present invention is not limited to these examples, and is intended to include all modifications which fall within the scope of the claims and the meaning and scope of equivalents thereof.

### Embodiment 1

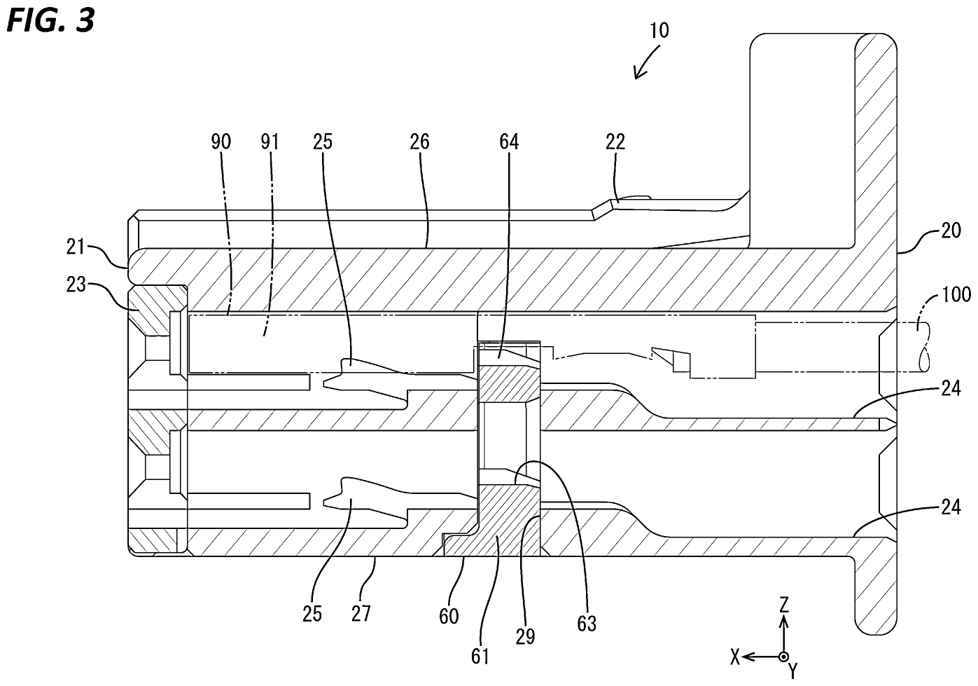

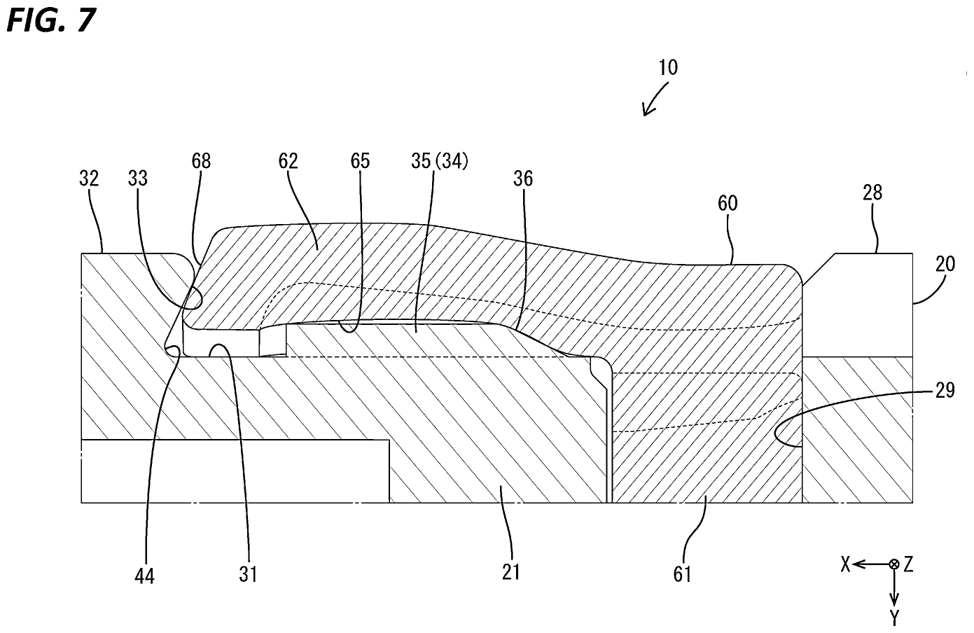

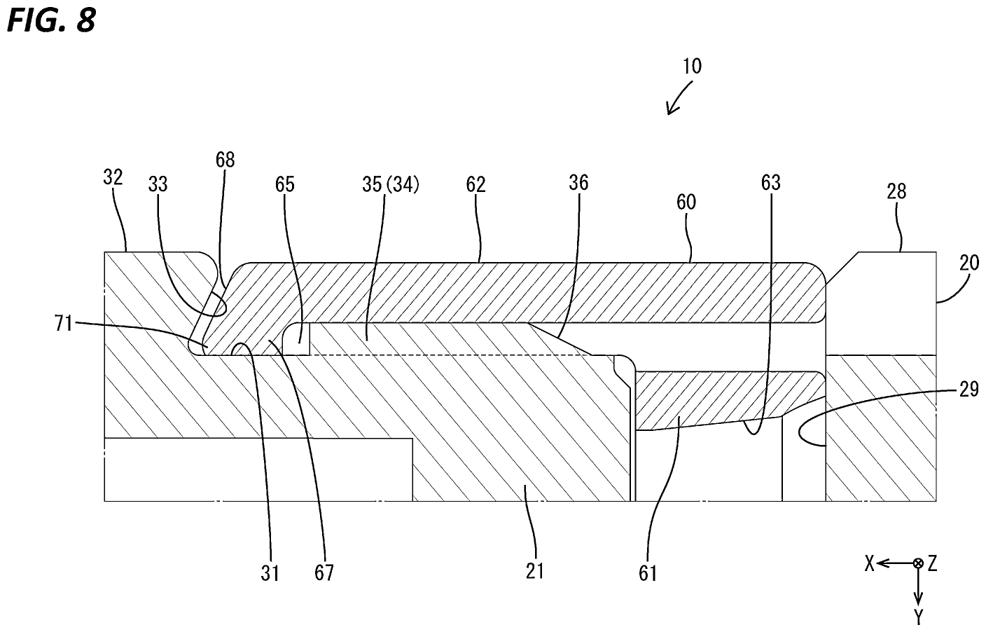

As shown in FIG. 3, a connector 10 according to Embodiment 1 includes a housing 20, a terminal fitting 90 configured to be accommodated in the housing 20, and a retainer 60 configured to be movably mounted to the housing 20. The housing 20 is configured to be fitted to a counterpart connector (not shown). In the following description, a side of the housing 20 that faces the counterpart connector at the start of fitting is the front side in the front-rear direction. The up-down direction is defined based on the up-down directions of the drawings excluding FIGS. 7 and 8. The up-down direction is synonymous with the height direction. The left-right direction is a direction orthogonal to the up-down direction and the front-rear direction. The left-right direction is synonymous with the width direction. In the drawings, the front side is denoted by reference character X, the lateral side (here, the right side as viewed from the front side) is denoted by reference character Y, and the upper side is denoted by reference character Z. These directions are defined for the sake of convenience, and do not necessarily coincide with the corresponding directions in a state in which the connector 10 is mounted in a vehicle (not shown) or the like.

### Housing 20 and Terminal Fitting 90

The housing 20 is made of a synthetic resin, and includes, as shown in FIG. 3, a housing body 21, a lock arm 22 protruding from an upper surface 26 of the housing body 21, and a front member 23 that is separate from the housing body 21 and covers a front surface of the housing body 21. The lock arm 22 is elastically deformable in the up-down direction, and configured to lock a counterpart connector (not shown) so as to hold the counterpart connector and the housing 20 in a fitted state.

The housing body 21 has a plurality of cavities 24 extending therethrough in the front-rear direction, and elastically deformable lances 25 protruding forward from inner walls of the respective cavities 24.

The terminal fitting 90 is made of a conductive metal, and is inserted into the corresponding one of the cavities 24 from behind. The terminal fitting 90 is illustratively shown as a female terminal, and includes a tubular box portion 91 at the front thereof. The box portion 91 is configured to receive a tab of a counterpart terminal fitting (not shown), and be electrically connected to the counterpart terminal fitting. The rear of the terminal fitting 90 is crimped to a terminal portion of a wire 100 so as to be electrically and mechanically connected thereto. The front member 23 stops the box portion 91 at the front, and inhibits the terminal fitting 90 from being dislodged forward.

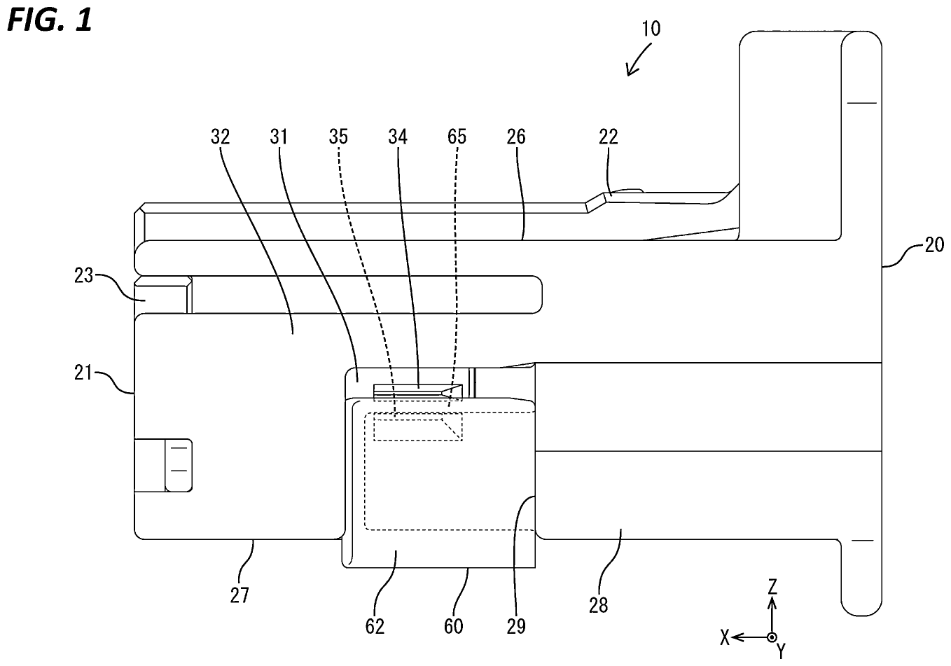

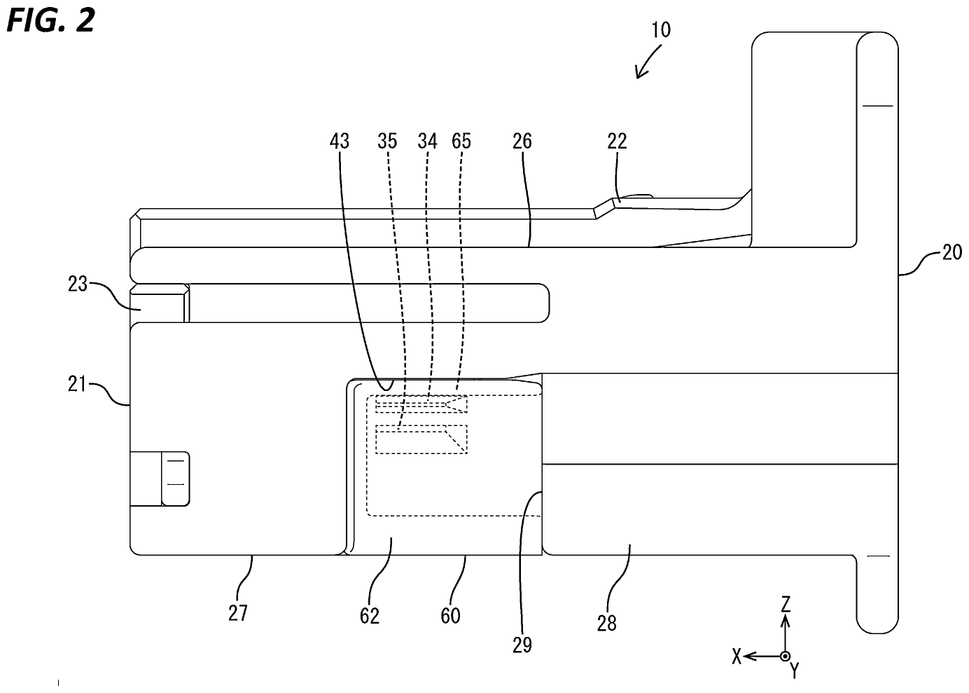

The housing body 21 has an outer surface that faces outward. As shown in FIGS. 1 and 2, the outer surface of the housing body 21 includes an upper surface 26 to which the lock arm 22 is coupled, one surface 27 serving as a bottom surface (lower surface), and a pair of side surfaces 28 (only the right side surface 28 is shown) that face leftward and rightward, respectively, so as to intersect the upper surface 26 and the one surface 27.

The one surface 27 is disposed horizontally along the front-rear direction. The side surfaces 28 are disposed perpendicularly along the up-down direction.

The housing body 21 has a retainer attachment hole 29 that is open so as to span the one surface 27 and the side surfaces 28. As shown in FIG. 3, the retainer attachment hole 29 is in communication with the cavities 24 inside the housing body 21, and is disposed rearward of the lances 25. A body portion 61, described below, of the retainer 60 is inserted into the retainer attachment hole 29 from the opening of the retainer attachment hole 29 in the one surface 27.

As shown in FIGS. 1, 7, and 8, each of the side surfaces 28 of the housing body 21 has, at a portion thereof extending forward from the opening of the retainer attachment hole 29, an opposing surface 31 extending along the up-down direction and the front-rear direction. The opposing surface 31 is disposed so as to oppose a side plate portion 62, described below, of the retainer 60. Each of the side surfaces 28 of the housing body 21 has, at a position forward of the opposing surface 31, an outer side surface 32 disposed outward of the opposing surface 31 in the left-right direction.

In addition, as shown in FIGS. 7 and 8, each of the side surfaces 28 of the housing body 21 includes a stepped pressing portion 33 between the opposing surface 31 and the outer side surface 32. The pressing portion 33 is an inverse tapered surface that is inclined from the opposing surface 31 toward the outer side surface 32. In each of the side surfaces 28 of the housing body 21, the pressing portion 33 and the opposing surface 31 form a cross-sectionally V-shaped groove portion 44 constituting a part of a dovetail groove. The pressing portion 33 is disposed so as to cover a front end portion of the corresponding side plate portion 62 of the retainer 60 from outside, and inhibits the side plate portion 62 from being lifted outward.

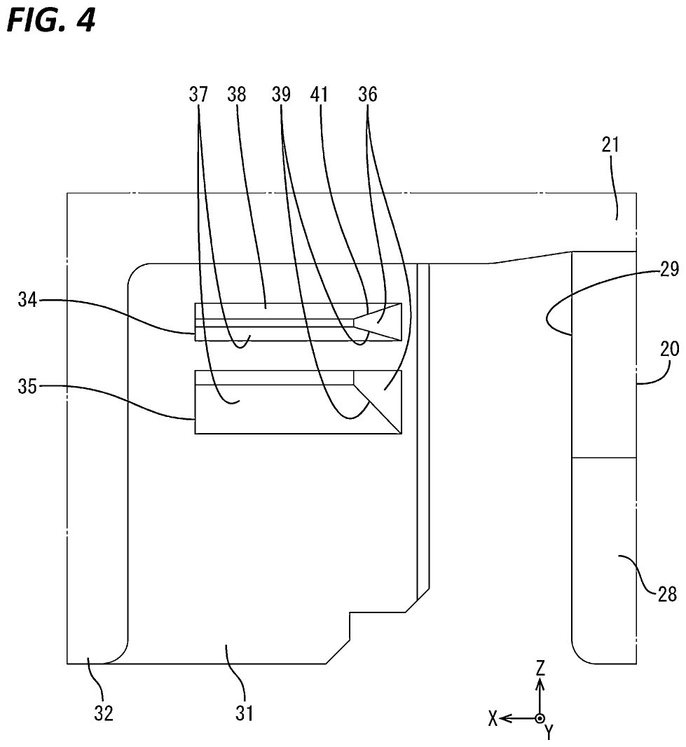

As shown in FIG. 4, locking portions 34 and 35 protrude from the opposing surface 31 of each of the side surfaces 28 of the housing body 21. The locking portions 34 and 35 include a full locking portion 34, and a partial locking portion 35 disposed below the full locking portion 34. Both the full locking portion 34 and the partial locking portion 35 have the shape of a rib extending in the front-rear direction. The thickness of the partial locking portion 35 in the up-down direction is larger than the thickness of the full locking portion 34 in the up-down direction. The full locking portion 34 and the partial locking portion 35 are locked to a locked portion 65, described below, of the retainer 60, and serve to hold the retainer 60 at a full locking position and a partial locking position, respectively, relative to the housing 20. In the following description, when there is no need to distinguish between the full locking portion 34 and the partial locking portion 35, the full locking portion 34 and the partial locking portion 35 are simply referred to as locking portions 34 and 35.

The locking portions 34 and 35 are disposed at portions of the opposing surface 31 that are located above the center in the up-down direction. In addition, the locking portions 34 and 35 are disposed close to the retainer attachment hole 29. Rear surfaces of the locking portions 34 and 35 are end faces that face toward the opening of the retainer attachment hole 29 in the side surface 28. An inclined surface portion 36 that is inclined forward, i.e., in a direction away from the retainer attachment hole 29, is formed on each of the rear surfaces of the locking portions 34 and 35. The inclined surface portions 36 are inclined at an inclination angle of 45 degrees or less relative to the planar direction (front-rear direction) of the opposing surface 31. The respective inclined surface portions 36 of the full locking portion 34 and the partial locking portion 35 are inclined at the same inclination angle.

Second inclined surface portions 37 that are inclined upward toward the proximal end surfaces, in the protruding direction, of the locking portions 34 and 35 are formed on lower surfaces of the locking portions 34 and 35, respectively. A third inclined surface portion 38 that is inclined downward toward a proximal end surface of the full locking portion 34 in the protruding direction is formed on an upper surface of the full locking portion 34. The proximal end surfaces of the locking portions 34 and 35 in the protruding direction are perpendicular surfaces that are elongated in the front-rear direction. An upper surface of the partial locking portion 35 is a horizontal surface that is elongated in the front-rear direction.

Each of the locking portions 34 and 35 includes, between the inclined surface portion 36 and the second inclined surface portion 37, a linear ridge portion 39 that is inclined upward to the front from a rear end of the locking portion 34 or 35. The ridge portion 39 of the partial locking portion 35 is formed to be longer than the ridge portion 39 of the full locking portion 34. The full locking portion 34 includes, between the inclined surface portion 36 and the third inclined surface portion 38, an upper ridge portion 41 that is inclined downward to the front from a rear end of the full locking portion 34. Front surfaces of the locking portions 34 and 35 are perpendicular surfaces that are elongated in the up-down direction.

### Retainer 60

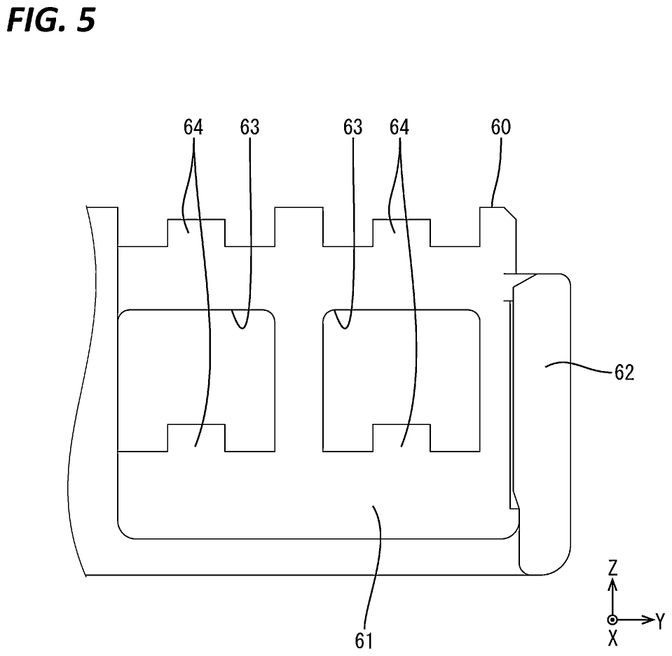

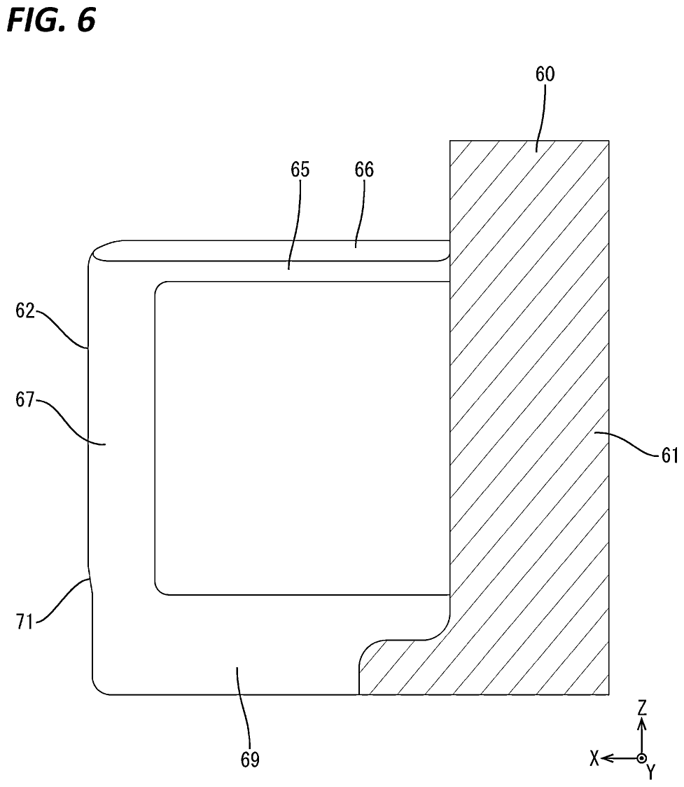

The retainer 60 is made of a synthetic resin, and although not shown entirely, includes a body portion 61 that is elongated in the left-right direction, and a pair of side plate portions 62 (only one side plate portion 62 is shown) that protrude forward from left and right end portions, respectively, of the body portion 61, as shown in FIGS. 5 and 6. As shown in FIG. 3, the body portion 61 is disposed inside the retainer attachment hole 29, and is moved inside the retainer attachment hole 29 between the partial locking position and the full locking position in the up-down direction. As shown in FIGS. 7 and 8, each of the side plate portions 62 is disposed so as to cover the corresponding opposing surface 31 of the housing 20.

As shown in FIG. 5, the body portion 61 has a plurality of through holes 63 extending therethrough in the front-rear direction. The through holes 63 are disposed in the body portion 61 so as to be arranged in the left-right direction. The body portion 61 includes a plurality of retaining portions 64 that protrude from inner lower surfaces of the respective through holes 63. The retaining portions 64 are formed also on an upper surface of the body portion 61 so as to be arranged in the left-right direction. With the body portion 61 disposed inside the retainer attachment hole 29, the through holes 63 are disposed so as to be in communication with the lower cavity 24. The retaining portions 64 are disposed so as to respectively correspond to the upper and lower cavities 24.

When the retainer 60 is at the partial locking position relative to the housing 20, the retaining portions 64 are disposed so as to be retracted from an insertion path of the terminal fitting 90, thus allowing the terminal fitting 90 to be inserted into the cavity 24. As shown in FIG. 4, when the retainer 60 is at the full locking position relative to the housing 20, the retaining portions 64 enter the insertion path of the terminal fitting 90, and are disposed on a rear surface of the box portion 91 so as to be locked thereto. The terminal fitting 90 is held inside the cavity 24 in a retained state by the retaining portions 64.

As shown in FIG. 6, each of the side plate portions 62 has a plate shape with a plate surface facing in the left-right direction, and exhibits a square outer shape in a side view. Each of the side plate portions 62 is configured to be elastically deformable in the left-right direction, using a rear end portion thereof coupled to the body portion 61 as a supporting point. As shown in FIGS. 7 and 8, a pressed portion 68 that is inclined rearward toward the outer side in the left-right direction is formed on a proximal end surface of each of the side plate portions 62. The pressed portion 68 is disposed so as to be covered by the pressing portion 33.

As shown in FIG. 6, a locked portion 65 protrudes from an inner surface of each of the side plate portion 62. The locked portion 65 has a rib shape extending in the front-rear direction, and is formed at an upper end portion of an inner surface of the corresponding side plate portion 62 so as to extend along the upper end portion. An inclined surface 66 that is inclined downward from an upper end face of the corresponding side plate portion 62 toward a proximal end surface thereof in the protruding direction is formed on an upper surface of the locked portion 65. A lower surface of the locked portion 65 is a horizontal surface extending in the front-rear direction.

A longitudinal rib 67 extending in the up-down direction protrudes from the inner surface of each of the side plate portions 62. An upper end portion of the longitudinal rib 67 is coupled integrally to a front end portion of the locked portion 65. A front surface of the longitudinal rib 67 faces a front end of the corresponding side plate portion 62. In addition, a lateral rib 69 extending in the front-rear direction protrudes from the inner surface of each of the side plate portions 62. A front end portion of the lateral rib 69 is integrally coupled to a lower end portion of the longitudinal rib 67. A lower surface of the lateral rib 69 faces a lower end of the side plate portion 62. A frame portion 71 having a gate shape is formed in one piece with the inner surface of each of the side plate portions 62 by the locked portion 65, the longitudinal rib 67, and the lateral rib 69.

### Operation of Connector 10

The body portion 61 of the retainer 60 is inserted into the retainer attachment hole 29 through the opening of the one surface 27 from below relative to the housing 20. In the process of mounting the retainer 60, the inclined surface 66 of the locked portion 65 slides on the second inclined surface portion 37 of the partial locking portion 35, and, as shown in FIG. 7, also slides on the inclined surface portion 36 of the partial locking portion 35, whereby the side plate portion 62 is elastically deformed outward in the left-right direction, using the rear end portion thereof as a supporting point. The pressed portion 68 on the proximal end surface side of the plate portion 62 comes into contact with the pressing portion 33 of the housing 20 from the inner side in the left-right direction, thus inhibiting the side plate portion 62 from opening outward in the left-right direction. With the contact portion of the pressed portion 68 with the pressing portion 33, and the rear end portion serving as a supporting point of deflection movement, the side plate portion 62 apparently forms a double-supported state that constitutes a double-supported beam. While the side plate portion 62 is elastically deformed to form the double-supported state, the stress acting on the partial locking portion 35 from the locked portion 65 is dispersed in the length direction of the inclined surface portion 36 and the ridge portion 39 (the direction away from the opening of the retainer attachment hole 29). Accordingly, excessive stress will not be applied to the partial locking portion 35. As a result, it is possible to prevent the occurrence of sagging by which the partial locking portion 35 is cut away or deformed by the locked portion 65.

Upon the locked portion 65 clearing the partial locking portion 35, the side plate portion 62 is elastically returned to the original state (a natural state in which it is not elastically deformed) promptly, and the locked portion 65 is fitted between the partial locking portion 35 and the full locking portion 34 as shown in FIG. 1. At this time, the lower surface of the locked portion 65 is disposed opposing the upper surface of the partial locking portion 35 so as to be in contact therewith, and the upper surface of the locked portion 65 is disposed opposing the lower surface of the full locking portion 34 so as to be in contact therewith. Thus, the retainer 60 is held at the partial locking position relative to the housing 20.

When the retainer 60 is at the partial locking position relative to the housing 20, a lower end portion of the retainer 60 is disposed protruding downward from the one surface 27 of the housing body 21. As shown in FIG. 8, the pressed portion 68 of the side plate portion 62 is disposed away from the pressing portion 33 of the housing 20, whereby the double-supported state of the side plate portion 62 is cancelled. At the partial locking position, the side plate portion 62 forms a cantilevered state in the form of a cantilever that is elastically deformable, using only a rear end portion continuous with the body portion 61 as a supporting point. When the retainer 60 is at the partial locking position relative to the housing 20, the terminal fitting 90 is inserted into the cavities 24 from behind. The terminal fitting 90 is connected to a terminal portion of the wire 100 in advance.

After the terminal fitting 90 has been inserted into the cavities 24, the retainer 60 is pressed upward. Then, the locked portion 65 slides on the second inclined surface portion 37 and the inclined surface portion 36 of the full locking portion 34, whereby the side plate portion 62 is elastically deformed outward in the left-right direction, using the rear end portion as a supporting point (see FIG. 7). As described above, the pressed portion 68 of the side plate portion 62 comes into contact with the pressing portion 33 of the housing 20 from the inner side in the left-right direction, thus inhibiting the side plate portion 62 from opening outward in the left-right direction. While the side plate portion 62 is elastically deformed to form the double-supported state, the stress acting on the full locking portion 34 from the locked portion 65 is dispersed in the length direction of the inclined surface portion 36 and the ridge portion 39. Accordingly, excessive stress will not be applied to the full locking portion 34. As a result, it is possible to prevent the occurrence of deformation (sagging) in the full locking portion 34.

Upon the locked portion 65 clearing the full locking portion 34, the side plate portion 62 is elastically returned to the original state (a natural state in which it is not elastically deformed) promptly, and the locked portion 65 is fitted between the full locking portion 34 and the stepped surface 43 that defines an upper end of the opposing surface 31, as shown in FIG. 2. At this time, the lower surface of the locked portion 65 is disposed opposing the upper surface of the full locking portion 34 so as to be in contact therewith, and the upper surface of the locked portion 65 is disposed so as to be in contact with the stepped surface 43. Accordingly, the retainer 60 is held at the full locking position relative to the housing 20. At the full locking position, the side plate portion 62 forms a cantilevered state in the form of a cantilever (see FIG. 8). Then, upon the retainer 60 reaching the full locking position, the retaining portion 64 is disposed so as to lock the terminal fitting 90, as shown in FIG. 3. A lower surface of the retainer 60 is disposed on the one surface 27 of the housing body 21 without any height difference.

As described thus far, the retainer 60 of Embodiment 1 includes a body portion 61 disposed inside the retainer attachment hole 29 and capable of locking the terminal fitting 90, and side plate portions 62 protruding in a cantilevered manner from the body portion 61 in a direction intersecting the direction of movement of the retainer 60 and covers the side surfaces 28 of the housing 20 from outside. The side plate portions 62 each include a locked portion 65 that protrudes from an inner surface of the housing 20 that opposes the side surface 28 and configured to be locked to the locking portions 34 and 35 at both the partial locking position and the full locking position. The locking portions 34 and 35 each include, on an end face thereof facing toward an opening of the retainer attachment hole 29, an inclined surface portion 36 that is inclined in a direction away from the opening of the retainer attachment hole 29.

At the time of mounting the retainer 60 to the partial locking position or moving the retainer 60 from the partial locking position to the full locking position, the locked portion 65 is caused to ride on the locking portions 34 and 35 while the side plate portions 62 are elastically deformed. Upon the locked portion 65 coming into contact with the inclined surface portions 36, the stress acting on the locking portions 34 and 35 is dispersed in the length direction of the inclined surface portions 36. Accordingly, stress will not be focused on a part of each of the side plate portions 62, and therefore the side plate portions 62 can be elastically deformed smoothly, thus making it possible to enhance the operability of the retainer 60. In addition, each of the locking portions 34 and 35 can be extended toward the opening of the retainer attachment hole 29 by the length of the corresponding inclined surface portion 36, and it is therefore possible to secure the necessary locking force between each of the locking portions 34 and 35 and the locked portion 65, thus increasing the retaining force of the retainer 60.

In addition, the inclined surface portions 36 are each inclined at an inclination angle of 45 degrees or less relative to the planar direction of the corresponding side surface 28 of the housing 20. By doing so, it is possible to increase the length of the inclined surface portion 36, thus enhancing the effect of dispersing the stress acting on the locking portions 34 and 35. In addition, the lengths of the locking portions 34 and 35 including the inclined surface portions 36 can also be increased, and it is therefore possible to secure a sufficient locking force between each of the locking portions 34 and 35 and the locked portion 65.

Furthermore, the side surfaces 28 of the housing 20 each include, at a position opposite to the opening side of the retainer attachment hole 29 with the locking portions 34 and 35 interposed therebetween, a pressing portion 33 that opposes a distal end portion (pressed portion 68), in the protruding direction, of the side plate portion 62 from outside. Also, each of the side plate portions 62 is configured to be displaceable between a cantilevered state in which the side plate portion 62 is disposed away from the pressing portion 33, and a double-supported state in which the side plate portion 62 is disposed in contact with the pressing portion 33 by the locked portion 65 riding on the locking portions 34 and 35.

As a result of the pressed portion 68 of each of the side plate portions 62 coming into contact with the corresponding pressing portion 33, the side plate portion 62 is inhibited from being lifted from the side surface 28. When the locked portion 65 is caused to ride on the locking portions 34 and 35 at the time of mounting the retainer 60 to the partial locking position or moving the retainer 60 from the partial locking position to the full locking position, the side plate portion 62 can be elastically deformed into a double-supported state, using the coupling portion to the body portion 61 and the contact portion with the pressing portion 33 as supporting points. As the locked portion 65 clears the locking portions 34 and 35, the side plate portion 62 is elastically returned promptly, thus making it possible to realize a locked state between the locked portion 65 and each of the locking portions 34 and 35 with a good tactile feel. At the time of mounting the retainer 60 to the partial locking position or at the beginning of moving the retainer 60 from the partial locking position to the full locking position, the side plate portion 62 is maintained in a cantilevered state, and it is therefore possible to reduce the mounting resistance or the movement resistance as compared with the case of a double-supported state.

Furthermore, in Embodiment 1, the locking portions 34 and 35 include the partial locking portion 35 configured to lock the locked portion 65 at the partial locking position, and the full locking portion 34 configured to lock the locked portion 65 at the full locking position. Also, the surface portion 36 is provided on both the full locking portion 34 and the partial locking portion 35.

Therefore, the locked portion 65 is caused to ride on the partial locking portion 35 at the time of mounting the retainer 60 to the partial locking position, and the locked portion 65 is caused to ride on the full locking portion 34 at the time of moving the retainer 60 to the full locking position. In both the state of mounting the retainer 60 and the state of moving the retainer 60, the operability and the retaining force of the retainer 60 can be enhanced by the inclined surface portions 36 respectively formed on the full locking portion 34 and the partial locking portion 35.

Furthermore, the respective inclined surface portions 36 of the full locking portion 34 and the partial locking portion 35 have the same inclination angle relative to the planar direction of the side surface 28. Accordingly, the side plate portion 62 can be elastically deformed in the same manner when the locked portion 65 is caused to ride on each of the partial locking portion 35 and the full locking portion 34, and it is therefore possible to ensure smooth deflection movement of the side plate portion 62. Moreover, the structure of a mold for molding the inclined surface portion 36 will not become complicated.

### Other Embodiments of the Present Disclosure

It should be appreciated that Embodiment 1 presently disclosed is in all respects illustrative and not limiting.

In Embodiment 1 described above, the side plate portions 62 are formed so as to protrude forward from left and right end portions of the body portion 61, and the locking portions 34 and 35 are disposed in areas located forward of the retainer attachment hole 29 in the side surfaces 28 of the housing 20. In contrast, in other embodiments, the side plate portions may be formed so as to protrude rearward from left and right end portions of the body portion, and the locking portions may be disposed in areas located rearward of the retainer attachment hole in the side surfaces of the housing.

In Embodiment 1 described above, the locked portion 65 is disposed so as to be locked to the locking portions 34 and 35 at both the full locking position and the partial locking position, and the inclined surface portion 36 is formed on both the full locking portion 34 and the partial locking portion 35. In contrast, in other embodiments, the locked portion may be disposed so as to be locked to the locking portions at one of the partial locking position and the full locking position, and the inclined surface portion may be formed on one of the full locking portion and the partial locking portion.

In Embodiment 1 described above, the locked portion 65 is configured to come into complete contact with the inclined surface portions 36 of the locking portions 34 and 35 at the time of mounting the retainer 60 to the partial locking position or moving the retainer 60 from the partial locking position to the full locking position. In contrast, in other embodiments, the locked portion may be configured to come into partial contact with the inclined surface portions of the locking portions, or not to come into contact with the inclined surface portions at the time of mounting the retainer to the partial locking position or moving the retainer from the partial locking position to the full locking position. According to the other embodiments, it is possible to reduce the contact resistance of the locked portion with the locking portions, and reduce the amount of elastic deformation of the side plate portions, thus further enhancing the operability of the retainer.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a terminal fitting;
a housing configured to accommodate the terminal fitting; and
a retainer disposed so as to be movable between a partial locking position and a full locking position relative to the housing,
wherein the housing includes one surface, a side surface intersecting the one surface, a retainer attachment hole that is open in the one surface and the side surface, and a locking portion protruding from the side surface,
the retainer includes a body portion disposed inside the retainer attachment hole and capable of locking the terminal fitting, and a side plate portion that protrudes from the body portion in a direction intersecting a direction of movement of the retainer and covers the side surface from outside,
the side plate portion includes a locked portion protruding from an inner surface opposing the side surface and configured to be locked to the locking portion at at least one of the partial locking position and the full locking position, and
the locking portion includes, on an end face thereof facing toward an opening of the retainer attachment hole, an inclined surface portion that is inclined in a direction away from the opening of the retainer attachment hole.

2. The connector according to claim 1, wherein the inclined surface portion is inclined at an inclination angle of 45 degrees or less relative to a planar direction of the side surface.

3. The connector according to claim 1,
wherein the side surface includes, at a position opposite to the opening side of the retainer attachment hole with the locking portion interposed therebetween, a pressing portion that opposes a distal end portion, in a protruding direction, of the side plate portion from outside, and
the side plate portion is configured to be displaceable between a cantilevered state in which the side plate portion is disposed away from the pressing portion, and a double-supported state in which the side plate portion is disposed in contact with the pressing portion by the locked portion riding on the locking portion.

4. The connector according to claim 1,
wherein the locking portion comprises a partial locking portion configured to lock the locked portion at the partial locking position, and a full locking portion configured to lock the locked portion at the full locking position, and
the inclined surface portion is provided on both the full locking portion and the partial locking portion.

5. The connector according to claim 4, wherein the respective inclined surface portions of the full locking portion and the partial locking portion have the same inclination angle relative to the planar direction of the side surface.
